(19) United States
(12) Patent Application Publication
(10) Pub. No.: US 2009/0249078 A1
(43) Pub. Date: Oct. 1, 2009

(54) OPEN ID AUTHENTICATION METHOD USING IDENTITY SELECTOR

(75) Inventors: Seung Hyun Kim, Daejeon (KR); Dae Seon Choi, Daejeon (KR); Deok Jin Kim, Daejeon (KR); Soo Hyung Kim, Daejeon (KR); Jong Hyouk Noh, Daejeon (KR); Kwan Soo Jung, Daejeon (KR); Sang Rea Cho, Daejeon (KR); Young Seob Cho, Daejeon (KR); Jin Man Cho, Daejeon (KR); Seung Hun Jin, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/413,152

(22) Filed: Mar. 27, 2009

(30) Foreign Application Priority Data
Mar. 28, 2008 (KR) 10-2008-0028959
Jul. 30, 2008 (KR) 10-2008-0074725

(51) Int. Cl. H04L 9/32

(52) U.S. Cl. 713/185

(57) ABSTRACT

Provided is an Open ID authentication method using an identity selector, which can simplify the authentication of an open ID and reduce phishing and hacking risks by automatically performing an open ID-based login process without the need to manually input an open ID uniform resource locator (URL) to a login window.

### CROSS-REFERENCE TO RELATED APPLICATION

This application claims priority from Korean Patent Application No. 10-2008-0028959 filed on Mar. 28, 2008 in the Korean Intellectual Property Office, the disclosure of which is incorporated herein by reference in its entirety.

This application claims priority from Korean Patent Application No. 10-2008-0074725 filed on Jul. 30. 2008 in the Korean Intellectual Property Office, the disclosure of which is incorporated herein by reference in its entirety.

### BACKGROUND OF THE INVENTION

1. Field of the Invention

The present invention relates to an Open ID, and more particularly, to an open ID authentication method using an identity selector, which can simplify the authentication of a user using an open ID and can reduce phishing and hacking risks.

This work was supported by the IT program of MIC/ITTA[2007-S-601-02, Development of Self-Control Enhanced Electronics ID Wallet system]

2. Description of the Related Art

Open ID are a type of IDs that enable users to be successfully authenticated and thus to freely use various Internet services without the need to subscribe.

Open ID techniques mainly aim at separating the provision of services and the authentication of users and thus providing an ID authentication service that can be commonly used nearly for all websites.

Open ID techniques are generally characterized not by requiring the designation of an ID and a password for each website but by allowing a user to input an open ID to a login window and thus to access an authentication system and allowing the authentication system to authenticate the open ID and thus to authenticate the user. An open ID may have a URL format (such as hongildong@myid.net) and may include a user's ID and a path to an authentication system.

However, an open ID having a URL format may sometimes be longer than an ID or a password, and may thus be troublesome to type. In addition, in open ID techniques, a user may need to access an authentication system with his/her terminal and then to undergo a final password-based authentication process.

In addition, since open ID techniques are characterized by accessing an authentication system through a URL path, there is a great possibility of identity information of users being intercepted by illegitimate servers for phishing and hacking purposes.

### SUMMARY OF THE INVENTION

The present invention provides an Open ID authentication method using an identity selector, which can simplify the authentication of a user using an open ID by not requiring the user to type in an open ID uniform resource locator (URL) in a login window with the use of the identity selector.

The present invention also provides reducing phishing and keyboard hacking risks by enabling an identity selector to perform authentication on an open ID with the use of identity information of a user and a connection path to an open ID authentication system.

The present invention also provides inserting an identity selector in a web browser of a user or in a website so as to enable the identity selector to perform authentication on an open ID, minimizing modifications to source code of a website for the use of the identity selector and enabling the use of existing open ID protocols or existing open ID authentication modules almost without any modifications thereto.

According to an aspect of the present invention, there is provided an open ID authentication method performed by an identity selector, which is installed in a terminal equipped with a web browser and a plurality of open IDs and displays identity information including a path to an open ID authentication system on the screen of the terminal, the open ID authentication method including if the web browser accesses a website that supports the open IDs, transmitting identity information corresponding to one of the open IDs chosen by a user to the website; redirecting the website to a path to the open ID authentication system through the web browser along with an authentication request message; and allowing the open ID authentication system to provide authentication results regarding the chosen open ID to an open ID service module of the website through the web browser.

According to another aspect of the present invention, there is provided an open ID authentication method performed by a website, which is connected through a network to a terminal equipped with an identity selector having a plurality of pieces of identity information respectively corresponding to a plurality of open IDs and includes an identity selector driving module remote-controlling the identity selector, the open ID authentication method including if the terminal accesses a service module of a website including an open ID service module, issuing a request for the driving of the identity selector to the terminal; displaying the pieces of identity information on a screen of the terminal by driving the identity selector; and if the identity selector accesses an identity selector server using one of the pieces of identity information and submits one of the open IDs, transmitting an open ID authentication request message to an open ID authentication system which has authenticated the submitted open ID, receiving an authentication response message from the open ID authentication system and performing a login process.

According to the present invention, a terminal may access an open ID authentication system through a login interface of a website in order to authenticate an open ID. Thus, there is no need to perform password-based authentication.

In addition, it is possible to easily authenticate an open ID by directly providing identity information to an open ID authentication system instead of using a URL-type open ID access method.

Moreover, it is possible to reduce phishing and hacking risks by not using an URL text format to access an open ID authentication system.

Furthermore, it is possible to minimize modifications to source code of a website and an open ID authentication system.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram for explaining an Open ID authentication method using an identity selector, according to an exemplary embodiment of the present invention;

FIG. 2 illustrates a block diagram for explaining an open ID authentication method using an identity selector, according to another exemplary embodiment of the present invention;

FIG. 3 illustrates a diagram of an interface that can be provided to a user by an identity selector;

FIG. 4 illustrates a flowchart of the open ID authentication method of the exemplary embodiment of FIG. 1 or FIG. 2; and

FIG. 5 illustrates a diagram for explaining the redirection of a website to an open ID authentication system through a web browser.

### DETAILED DESCRIPTION OF THE INVENTION

The present invention will hereinafter be described in detail with reference to the accompanying drawings in which exemplary embodiments of the invention are shown.

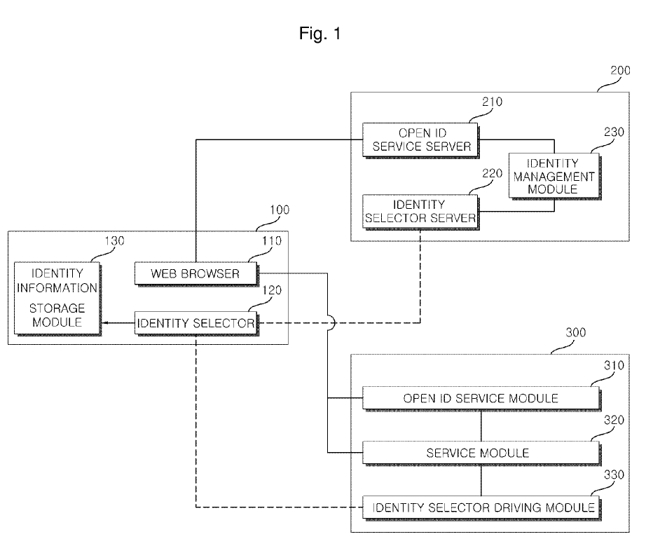

FIG. 1 illustrates a block diagram for explaining an Open ID authentication method using an identity selector, according to an exemplary embodiment of the present invention. Referring to FIG. 1, a terminal 100 may include a web browser 110 for accessing the Internet and an identity selector 120 safely managing the identity of a user. A website 300 may include an identity selector driving module 330 for driving the identity selector 120.

The identity selector 120 may store identity information necessary for authenticating each of one or more open IDs held by the user. The identity information may include uniform resource locator (URL) information of an open ID authentication system 200 for authenticating an open ID, the user's ID and password, and personal information of the user. The open IDs held by the user may be displayed as icons so as to be able to be easily recognized and chosen by the user. The identity selector 120 may be installed in the web browser 110 using an add-on installation method or may be realized as an independent application program. If the terminal 100 accesses the website 300 and attempts to log on to the website 300 with an open ID, the identity selector 120 may provide a number of open IDs to the user. If the user chooses one of the open IDs provided by the identity selector 120, the identity selector 120 may provide the chosen open ID to the website 300. More specifically, the identity selector 120 may display a number of open IDs as icons, and may transmit one of the icons chosen by the user to the website 300. Alternatively, the identity selector 120 may simply manage a number of open IDs, and the website 300 may drive the identity selector 120 to display an interface for choosing one of the open IDs managed by the identity selector 120. In this case, the client selector driving module 330 may issue a request for the driving of the identity selector 120 to the terminal 100 upon receiving a request for the authentication of an open ID from the terminal 100, and the identity selector 120 may display a number of open IDs on the screen of the terminal 100 as icons in response to the request issued by the client selector driving module 330. If the identity selector 120 analyzes an HTML source and recognizes that the website 300 includes an open ID module, the identity selector driving module 330 of the website 300 may be unnecessary.

Open ID identity information present in an identity information storage module 130 of the terminal 100 may be provided to the website 300 by the identity selector 120. The identity selector driving module 330 of the website 300 may provide an open ID provided by the identity selector 120 to the open ID authentication system 200. Thereafter, the open ID authentication system 200 may determine whether the user has attempted to log on to the website 300 with the open ID provided by the identity selector driving module 330, and may finally authenticate the user based on the results of the determination. The website 300 may be redirected to the open ID authentication system 200 by the identity selector 120. The website 300 may access an open ID service server 210 through the web browser 110 of the terminal 100.

The open ID authentication system 200 may authenticate the user based on open ID identity information provided to an identity selector server 220 by the identity selector 120. The open ID authentication system 200 may include the open ID service server 210, the identity selector server 220 and an identity management module 230.

The open ID service server 210 may authenticate the user by comparing an open ID provided by the website 300 through the web browser 110 of the terminal 100 with authentication session information present in the identity management module 230.

The identity selector server 220 may communicate with the identity selector 120 of the terminal 100, and may authenticate the chosen open ID provided by the terminal 100 with reference to the identity information present in the identity management module 230. If the terminal 100 is successfully authenticated, the identity selector server 220 may allocate an authentication session to the terminal 100.

The identity management module 230 may store identity information and login information provided by the terminal 100 when the terminal 100 subscribes to the open ID authentication system 200. The identity management module 230 may also store information indicating whether the user holds an authentication session. The website 300 may include an open ID service module 310, a service module 320, and the identity selector driving module 330. The open ID service module 310 may issue a request for the authentication of the user to the open ID authentication system 200, and particularly, the open ID service server 210 of the open ID authentication system 200. Then, the website 300 may verify authentication verification information provided thereto through the web browser 110 of the terminal 100, and may determine whether to provide a web service to the terminal 100 based on the results of the verification. If the website 300 decides to provide a web service to the terminal 100, the website 300 may provide the terminal 100 with a service requested by the terminal 100 through the service module 320.

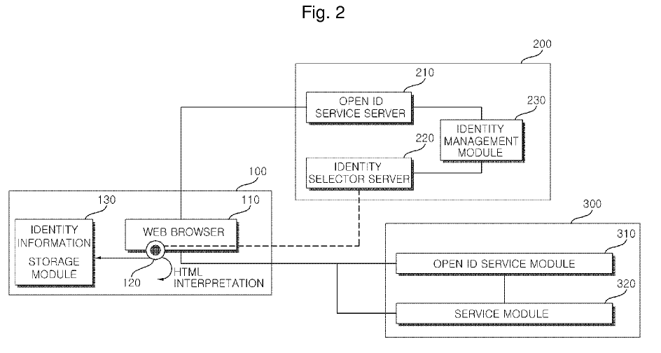

FIG. 2 illustrates a block diagram for explaining an open ID authentication method using an identity selector, according to another exemplary embodiment of the present invention. The exemplary embodiment of FIG. 2 is similar to the exemplary embodiment of FIG. 1 and is characterized in that a identity selector 120 is coupled to a web browser 110 as a tool bar, and that the identity selector 120 is driven only when performing an open ID-based login process in order for a terminal 100 to access a website 300.

Referring to FIG. 2, if the web browser 110 accesses the website 300 and then accesses a service module 320 of the website 300, the identity selector may analyze a source code of an open ID service module 310 and may determine whether the website 300 has performed a login process with an open ID. This will hereinafter be described in further detail with reference to Table 1 below.

TABLE 1

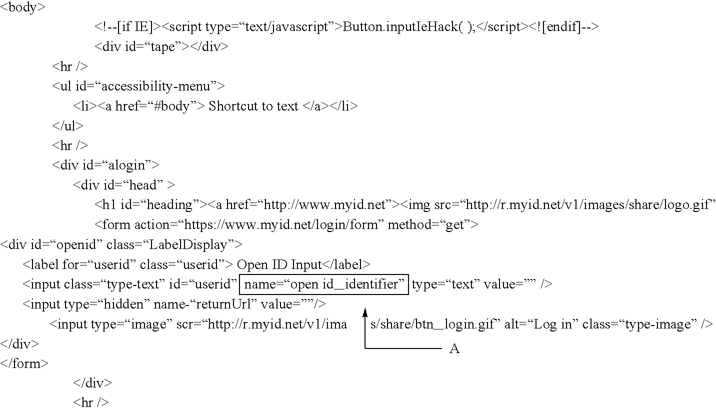

Table 1 shows an example of the source code of the service module 320. Referring to Table 1, the web browser 110 of the terminal 100 may reference the source code of the service module 320 when accessing an open ID login window.

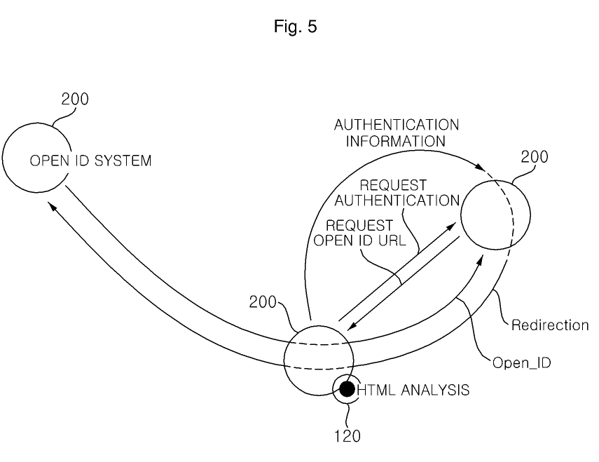

The body of the source code of the service module 320 includes a sentence A indicating an open ID. If the identity selector 120 is coupled to the web browser 110 as a tool bar, the identity selector 120 may serve as part of the web browser 110, and may reference the source code of the service module 320. The identity selector 120 may determine whether the web browser 110 requires open ID-based authentication to log on to the open ID service module 310 by referencing the source code of the service module 320. If it is determined that the web browser 110 requires open ID-based authentication to log on to the open ID service module 310, the identity selector 120 may redirect the open ID service module 310 to an open ID authentication system 200. This will hereinafter be described in further detail with reference to FIG. 5.

FIG. 5 illustrates a diagram for explaining the redirection of the website 300 to the open ID authentication system 200 through the web browser 110. Referring to FIGS. 2 and 5, the identity selector 120, which is coupled to the web browser 110 as a tool bar, issues a request for the authentication of a user to the website 300, and may provide an open ID chosen by the user to the website upon receiving a request for an open ID URL from the website 300. The open ID provided to the website 300 by the identity selector 300 may include a predetermined path to the open ID authentication system 200. Thus, the website 300 may access the open ID authentication system 200 through the predetermined path. The identity selector 120 and the open ID service module 310 may transmit authentication confirmation information of the terminal 100 to the open ID authentication system 200 through redirection, and the open ID service module 310 may perform final authentication on the user based on the authentication confirmation information. In this case, a display device (e.g., a liquid crystal display (LCD)) connected to the terminal 100 may not display any interface screen indicating whether the open ID authentication system 200 requests authentication.

That is, it is possible for the user to access the open ID authentication system 200 simply by choosing one of a number of open IDs displayed as icons with the use of a mouse without the need to type in a long open ID having the format of a URL and a password.

Once the terminal 100 is successfully authenticated by the open ID service module 310, the service module 320 may provide the user with various services provided by the website 300.

In order to improve the convenience of the use of an open ID, the open ID server 210 may perform an automatic login process using identity information.

Table 2 shows typical source code for processing an open ID-based login process.

TABLE 2

```
<form action=“https://www.myid.net/login/form” method=“get”>
<div id=“open ID” class=“LabelDisplay”>
      <label for=“userid” class=“userid”>open ID input </label>
      <input class=“type-text” id=“userid” name=“open ID_identifier”
type=“text” value=“” />
      <input type=“hidden” name=“returnUrl” value=“”/>
          <input type=“image”
src=“http://r.myid.net/v1/images/share/btn_login.gif”
alt=“login” class=“type-image” />
</div>
</form>
```

Table 2 shows source code of a login window located at a path “https://www.myid.net/login/form” method=“get”” and explains a typical open ID-based login process serviced by a website ‘www.myid.net’. Referring to Table 2, if the user types in a text-type open ID having the format of a URL, as indicated by “input class=“type-text” id=“userid” name=“open ID_identifier” type=“text” value=””, the website ‘www.myid.net’ may receive the text-type open ID and may perform a login process using the text-type open ID.

In order to realize an open ID-based automatic login process, source code shown in Table 3 below may be added to the source code shown in Table 2.

TABLE 3

```
<script language=“javascript”>
    function autoSubmit( )
    {
        Document.xxx.submit( );
        return;
    }
</script>
</head>
<body onLoad=“autoSubmit( );”>
<form name=xxxx action=“https://www.myid.net/login/form”
method=“get”>
<div id=“open ID” class=“LabelDisplay”>
<label for=“userid” class=“userid”> open ID input </label>
    <input class=“type-text” id=“userid” name=“open ID_identifier”
type=“text” value=“http://abc.com” />
    <input type=“hidden” name=“returnUrl” value=“”/>
        <input type=“image”
        src=“http://r.myid.net/v1/images/share/btn_login.gif” alt=“
login ” class=“type-image” />
</div>
</form>
```

Underlined parts of the source code shown in Table 3 may represent source code for performing an automatic login process, and particularly, an example of source code obtained by modifying the source code shown in Table 2. The source code shown in Table 3 may access a ‘form’ sentence using an autosubmit( ) function, and may then process a command in the ‘form’ sentence.

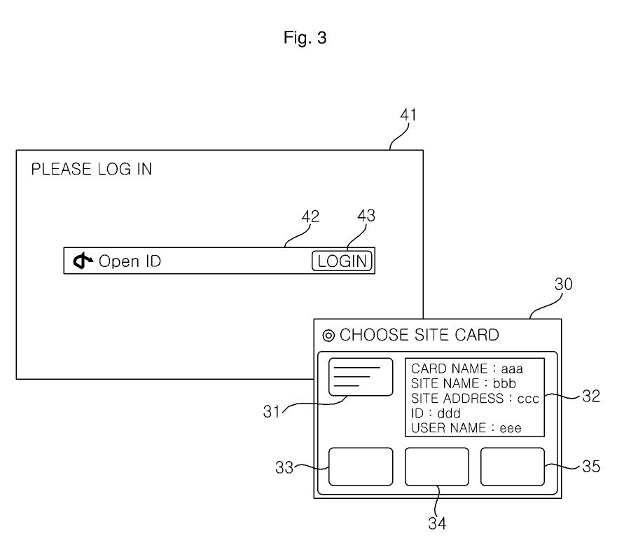

FIG. 3 illustrates a diagram of an interface provided to a user by an identity selector. Referring to FIG. 3, if a user accesses a website with a terminal, the website may perform an open ID-based authentication process. In this case, an interface 41 may be displayed by a display device of the terminal.

Referring to FIG. 3, reference numeral 42 indicates an open ID input window, reference numeral 43 indicates a button for performing a login process, and reference numeral 30 indicates an open ID selection window for choosing one of a plurality of open IDs 31, 33, 34 and 35 displayed by the display device of the terminal. The open IDs 31, 33, 34 and 35 may be displayed as icons. When the user chooses one of the open IDs 31, 33, 34 and 35 with the use of an input device such as a mouse, a detailed description 32 of the chosen open ID may be displayed. The detailed description 32 may include identity information corresponding to the chosen open ID (such as the name of the user, the name of a website, an ID and a card name) and other additional information.

If the user chooses one of the open IDs 31, 33, 34 and 35 displayed in the selection window 30, an identity selector may log on to a website along with an identity selector server of an open ID authentication system using setting information of the chosen open ID. Once the login process is successfully performed, the identity selector may provide the chosen open ID to the website. Then, an open ID service module of the website may access the open ID authentication system through a web browser of the user's terminal, and may thus perform authentication on the chosen open ID.

The interface 41 may be displayed on the screen of the terminal by an identity selector driving module of the website, as described above with reference to FIG. 1, or may be displayed on the screen of the terminal by an identity selector coupled to the web browser of the terminal as a tool bar, as described above with reference to FIG. 2.

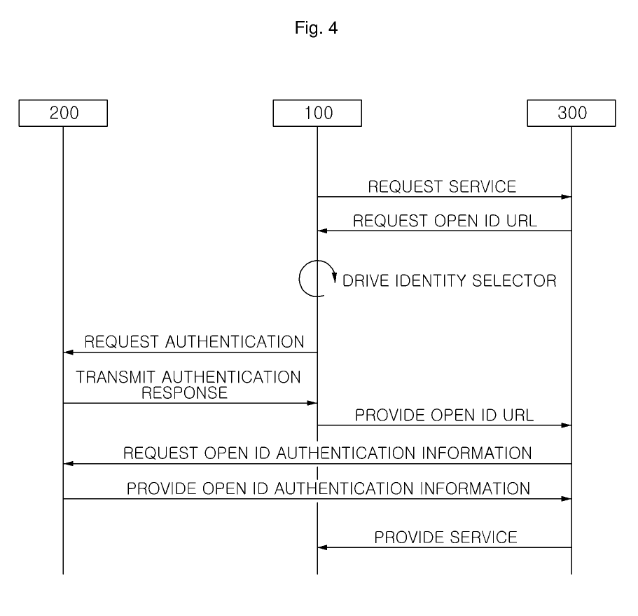

FIG. 4 illustrates a flowchart of the open ID authentication method of the exemplary embodiment of FIG. 1 or FIG. 2. Referring to FIG. 4, reference numerals 100, 200 and 300 indicate a terminal, an open ID authentication system and a website, respectively.

If the terminal 100 issues a request for a service to the website 300, the website 300 may issue a request for an open ID URL to the terminal 100. More specifically, the identity selector 120 of the terminal 100 may analyze source code of the website 300, and may thus determine whether the website 300 requires open ID-based authentication. If it is determined that the website 300 requires open ID-based authentication, the identity selector 120 of the terminal 100 may be driven. Thus, open ID identity information may be withdrawn from the identity information storage module 130, and the withdrawn open ID identity information may be displayed. Alternatively, the identity selector driving module 330 of the website 300 may drive the identity selector 120 of the terminal 100, and may display an interface, as shown in FIG. 3.

Once a number of pieces of open ID identity information are displayed using one of the above-mentioned methods, the user may choose one of the pieces of open ID identity information, and the chosen open ID identity information may be transmitted to the identity selector server 220 of the open ID authentication system 200. Thereafter, the terminal 100 may receive authentication result data, i.e., an authentication response, from the open ID authentication system 200.

Thereafter, the identity selector 120 may transmit an authentication request message regarding an open ID chosen by the user to the open ID authentication system 200.

Thereafter, the identity selector server 220 of the open ID authentication system 200 may authenticate the chosen open ID in response to the authentication request message transmitted by the identity selector 120. More specifically, the identity selector server 220 may compare identity information present in the identity management module 230 regarding the chosen open ID with identity information transmitted by the website 300, and may transmit the results of the comparison. The open ID authentication system 200 may store authentication results regarding the user in the identity management module 230 and may thus reuse the authentication results later when receiving a request for the authentication of the user again. The user may receive the authentication results regarding the user, i.e., an authentication response, from the open ID authentication system 200 through the identity selector 120, and may store the received authentication results in the identity management module 130 so that the authentication results can be reused later for reaccessing the open ID authentication system 200.

The identity selector 120 may transmit the open ID URL requested by the website 300 to the website 300. More specifically, the open ID URL requested by the website 300 may be included in the authentication response received by the user.

The website 300 may connect the web browser 110 of the terminal 100 to the open ID authentication system 200 using the open ID URL transmitted by the identity selector 120, and may issue a request for authentication information regarding the chosen open ID to the open ID authentication system 200. Then, the open ID authentication system 200 may determine whether to transmit the authentication information regarding the chosen open ID by referencing authentication verification information managed by the identity management module 230. Thereafter, the open D authentication system 200 may provide the authentication information regarding the chosen open ID to the website 300 through the web browser 110 of the terminal 100. Then, the website 300 may verify the authentication information provided by the open ID authentication system 200, and may provide the user with the service requested by the user.

The present invention can be applied to various open ID-based authentication systems and user terminals.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An Open ID authentication method performed by an identity selector, which is installed in a terminal equipped with a web browser and a plurality of open IDs and displays identity information including a path to an open ID authentication system on the screen of the terminal, the open ID authentication method comprising:
if the web browser accesses a website that supports the open IDs, transmitting identity information corresponding to one of the open IDs chosen by a user to the website;
redirecting the website to a path to the open ID authentication system through the web browser along with an authentication request message; and
allowing the open ID authentication system to provide authentication results regarding the chosen open ID to an open ID service module of the website through the web browser.

2. The open ID authentication method of claim 1, wherein the transmitting of the chosen open ID comprises:
displaying a plurality of icons respectively corresponding to the open IDs on the screen of the terminal;
displaying identity information corresponding to one of the open IDs chosen by the user on the screen of the terminal; and
transmitting the chosen open ID to the website.

3. The open ID authentication method of claim 2, wherein the transmitting of the chosen open ID further comprises:
if the web browser accesses the open ID service module, analyzing source code of a service module and determining whether the service module includes an open ID service module; and
choosing one of the open IDs to be used in the website and displaying the icon corresponding to the chosen open ID and an open ID service module corresponding to the chosen open ID on the screen of the terminal.

4. The open ID authentication method of claim 3, wherein the identity selector is driven only when the web browser accesses a service module of a website including an open ID service module.

5. The open ID authentication method of claim 1, wherein the identity selector is realized as a tool bar attached to the web browser.

6. The open ID authentication method of claim 1, wherein the identity selector is realized as an independent application program installed in the terminal.

7. The open ID authentication method of claim 1, wherein the website receives the identity information corresponding to the chosen open ID from the identity selector and performs an automatic login process by automatically inputting the user's ID and password included in the received identity information to a login window.

8. An open ID authentication method performed by a website, which is connected through a network to a terminal equipped with an identity selector having a plurality of pieces of identity information respectively corresponding to a plurality of open IDs and includes an identity selector driving module remote-controlling the identity selector, the open ID authentication method comprising:
if the terminal accesses a service module of a website including an open ID service module, issuing a request for the driving of the identity selector to the terminal;
displaying the pieces of identity information on a screen of the terminal by driving the identity selector; and
if the identity selector accesses an identity selector server using one of the pieces of identity information and submits one of the open IDs, transmitting an open ID authentication request message to an open ID authentication system which has authenticated the submitted open ID, receiving an authentication response message from the open ID authentication system and performing a login process.

9. The open ID authentication method of claim 8, wherein the performing of the login process comprises transmitting identity information corresponding to an open ID chosen by the terminal to the identity selector server and performing authentication on the identity information corresponding to the chosen open ID.

10. The open ID authentication method of claim 8, wherein each of the pieces of identity information includes a path to the open ID authentication system and the identity selector connects the web browser to the open ID authentication system through the path to the open ID authentication system.
